(19) United States
(12) Patent Application Publication
(10) Pub. No.: US 2004/0048580 A1
(43) Pub. Date: Mar. 11, 2004

(54) Base transceiver station

(76) Inventors: Tim Lunn, Cambridgeshire (GB); Nick Spencer, Cambridgeshire (GB); Chris Hancock, Hampshire (GB); Mark Paxman, Hertfordshire (GB)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/362,188

(22) PCT Filed: Jun. 20, 2002
(86) PCT No.: PCT/IB02/03119

(51) Int. Cl. H04B 1/38

(52) U.S. Cl. 455/73; 455/562.1

(57) ABSTRACT

A base transceiver station comprising a first part and a second part, said first part comprising a plurality of antennas and said second part being arranged to provide signals for transmission by said plurality of antennas, said first and second parts being connected by feeder means, said second part being arranged to provide a plurality of calibration signals to said first part, said first part comprising summing means for summing the calibration signals received at the first part and means for providing the summed calibration signals to said second part, said second part being arranged to process said summed calibration signals to determine correction values for application by said second part to signals for said plurality of antennas.

### FIELD OF THE INVENTION

The present invention relates to a base transceiver station and in particular, but not exclusively, to a base transceiver station having a phased antenna array.

### BACKGROUND TO THE INVENTION

With currently implemented cellular telecommunication networks, a base transceiver station (BTS) is provided which transmits signals intended for a given mobile station (MS), which may be a mobile telephone, throughout a cell sector served by that base transceiver station. However, in space division multiple access systems, the base transceiver station will only transmit a signal in a beam direction from which a signal from the mobile station is received. In other words, the base transceiver station does not transmit a signal throughout the cell or cell sector. Space division multiple access (SDMA) is only one example of beam steering. Other types of beam steering are known.

To direct the beam in a given direction, the base transceiver station has a phased antenna array. The antenna array will typically comprise a number of antennas for example 4 or 8, arranged with the spacing of for example a half of a wave length therebetween. A signal to be transmitted is supplied to each of the antennas but with different relative phases. Depending on these phase differences there will be constructive interference in the desired beam directions and destructive interference in the undesired directions. In order to ensure that the beam is provided only in the desired direction, it is important to ensure that the signal to be transmitted is provided to each of the antennas with the correct relative phase shift. In other words, the same signal is applied to each of the antennas but with different relative phases. The amplitudes of the signals may also differ. These phase and amplitude weights allow the beam to be shaped and steered.

It is important that the weights be accurately applied to the phased array antennas. Errors in the weights result in downgraded antenna performance, for example higher sidelobes, depointed beams or reduced gain.

The processing means which generate the relative phase shifts for the signals to be transmitted are usually some distance from the antennas. In particular, the antenna array is arranged at the top of a mast head with the processing means at the bottom. Accordingly, differences in the length of the cabling, wave guides or the like between each antenna and the processing means as well as differences in the temperature between the different cabling or the like can adversely effect the relative phases. Differences in the attenuation and phase length or attenuation of each path can result in errors in the weights that are applied to the antennas. If this occurs, then the beam may not be generated in the desired direction.

Phased antenna arrangements have attracted much interest for mobile communication applications because their use can increase call capacity, improve call quality and permit data transmission at higher speeds. These systems are often referred to as “smart antennas”. Calibration is of importance in smart antenna base stations because the antenna mounted at the top of the mast which is typically tens of metres high whilst the processing means is generally located at the base of the mast.

In the past, it has been proposed to have active calibration components at the mast head. For example, the entire calibration unit may be mounted at the mast head and include synthesisers, receivers and digital signal processors However, this is disadvantageous in that an active (i.e. requiring a power source), heavy unit is required at the top of the mast head.

Reference is made to U.S. Pat. No. 5,572,219 (General Electric Company). This patent discloses a method of calibrating a satellite which has a phased antenna array. The communication satellite has circuitry which generates calibration signals. Calibration signals are then transmitted by the communication satellite and are received at a remote control station on the ground. The remote control station carries out the analysis in order to calibrate the communication satellite. U.S. Pat. No. 5,677,696 (General Electric Company) discloses a similar system.

### SUMMARY OF THE INVENTION

It is an aim of embodiments of the present invention to address the above-mentioned problem.

In accordance with a first aspect of the present invention there is provided a base transceiver station comprising a first part and a second part, said first part comprising a plurality of antennas and said second part being arranged to provide signals for transmission by said plurality of antennas, said first and second parts being connected by feeder means, said second part being arranged to provide a plurality of calibration signals to said first part, said first part comprising summing means for summing the calibration signals received at the first part and means for providing the summed calibration signals to said second part, said second part being arranged to process said summed calibration signals to determine correction values for application by said second part to signals for said plurality of antennas.

A plurality of sets of calibration signals may be provided to said plurality of antennas. The number of sets of calibration signals may be equal to the number of antennas. A plurality of said sets of calibration signals may be provided in a single time slot. Only one of said sets of calibration signals may be provided in a single time slot. Said time slot comprises an idle time slot. Said calibration signals in a set may comprise the same signal, at least one of said sets having signals with a phase difference between at least two of said signals. Said phase difference comprises 180 degrees. Said phase difference between said signals may be applied at baseband. A station as claimed in claim 7 or 8, wherein said phase difference between said signals is applied at an intermediate or radio frequency. A matrix may be defined which comprises said plurality of sets of calibration signals. Said sets of said matrix are provided to the first part of the base station in turn.

Said second part may be arranged to correlate the summed calibration signal with a version of the calibration signal provided by the second part. The results of said correlation may be multiplied by the inverse of said matrix. Said second part may be arranged to provide a reference signal for compensating for phase ambiguities between calibrations.

Said plurality of antennas comprise a phased antenna array. The feeder means may comprise at least one cable. Separate feeder means may be provided for each of said antennas. In use the first part may be arranged at a mast head and said second part is arranged at the foot of said mast.

In a further aspect the present invention provides a method of calibrating a base transceiver station comprising a plurality of antennas, said method comprising the steps of: providing a plurality of calibration signals to a first part of said base station from a second part of the base station via feeder means; summing at the first part of the base station the calibration signals received from the second part; providing the summed calibration signals to the second part of the base station; and processing said summed calibration signals to determine correction values for application by said second part to signals for said plurality of antennas.

### BRIEF DESCRIPTION OF THE DRAWINGS

For a better understanding of the present invention and as to how the same may be carried into effect, reference will now be made by way of example to the accompanying drawings in which:

FIG. 1 shows a schematic view of a wireless telecommunications network;

FIG. 2 shows a simplified representation of a possible beam pattern provided by an antenna array;

FIG. 3 shows a block diagram of a first base transceiver station embodying the present invention;

FIG. 4 shows a flow diagram of a method embodying the present invention;

FIG. 5 provides a schematic representation of the calibration signal to be applied to each antenna;

FIG. 6 shows a block diagram of second base transceiver station embodying the present invention; and

FIG. 7 shows the idle slots used by the embodiment of FIG. 6.

### DETAILED DESCRIPTION OF EMBODIMENTS OF THE INVENTION

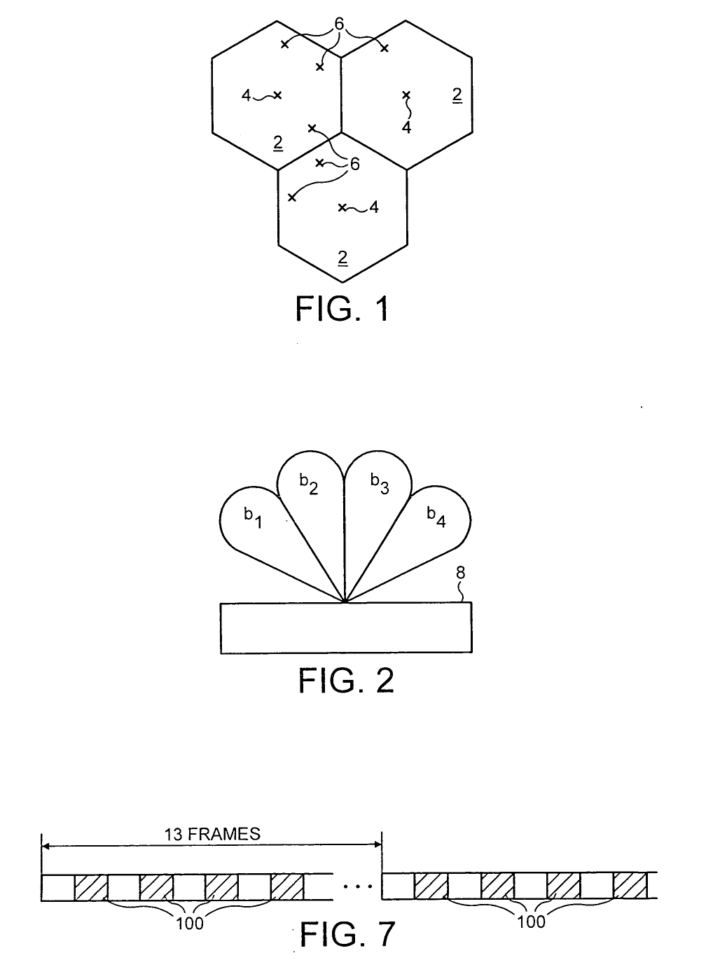

Reference will first be made to FIG. 1 in which three cells 2 of a mobile telephone network are shown. The three cells 2 are each served by a respective base transceiver station 4. Each base transceiver station 4 is arranged to communicate with the mobile stations 6. The mobile stations may be mobile telephones or any other suitable device.

The present embodiment is described in the context of a GSM (Global System for Mobile Communications) network. In the GSM system, a frequency/time division multiple access (F/TDMA) system is used. Data is generally transmitted between the base transceiver station and the mobile station in bursts. Each data burst is transmitted in a given frequency band in a predetermined time slot in that frequency band.

The use of a phased antenna array, sometimes also referred to as a directional antenna array or smart antenna array allows beam steering such as space division multiple access also to be achieved. Thus, in embodiments of the present invention, each data burst may be transmitted in a given frequency band, in a given time slot and in a given direction. The associated channel can be defined for a given data burst transmitted in the given frequency, in the given time slot and in the given direction. However, it should be appreciated that In some embodiments of the present invention, the same data burst can be transmitted in the same frequency band, in the same time slot but in two or more different directions. It should be appreciated that embodiments of the present invention can be used with other types of beam steering other than space division multiple access.

In a phased array antenna system which is to be used in an uncontrolled environment, for example outdoors, it is important that calibration of the system takes place as frequently as possible. This reduces the errors resulting from, for example, rapid changes in temperature.

FIG. 2 shows the directional radiation pattern which may be achieved by a phased antenna array 8 comprising four antennas (not shown) spaced apart by a distance equal to half a wave length. The antenna array 8 can be controlled to provide a beam b1 . . . b4 in any one of the four directions illustrated in FIG. 2. For example, the antenna array 8 could be controlled to transmit a signal to a mobile station only in the direction of b2 or only in the direction of b3. It is also possible to control the antenna array to transmit a signal in more than one beam direction at the same time. It should be appreciated that FIG. 2 is only a schematic representation of four possible beam directions which could be achieved with the antenna array 8. The total number of beams provided can be altered as required.

In preferred embodiments of the present invention, the antenna array is a digital array. This means that the angular spread of each beam may be varied as can the angle of transmission by digitally controlling the signal phase on each element of the array. The number of beams can also be altered. The pattern shown in FIG. 2 can be achieved by a digital phased antenna array. However, this would just be one of the possible patterns that could be achieved with such a digital phased antenna array. The digital phased antenna array, used in preferred embodiments of the present invention, provides more flexibility than an analogue array. However, in other embodiments of the present invention, only a given number of beam directions such as shown in FIG. 2 may be provided. In either case there will generally be an overlap between adjacent beams to ensure that all of the cell 2 is served by the antenna array.

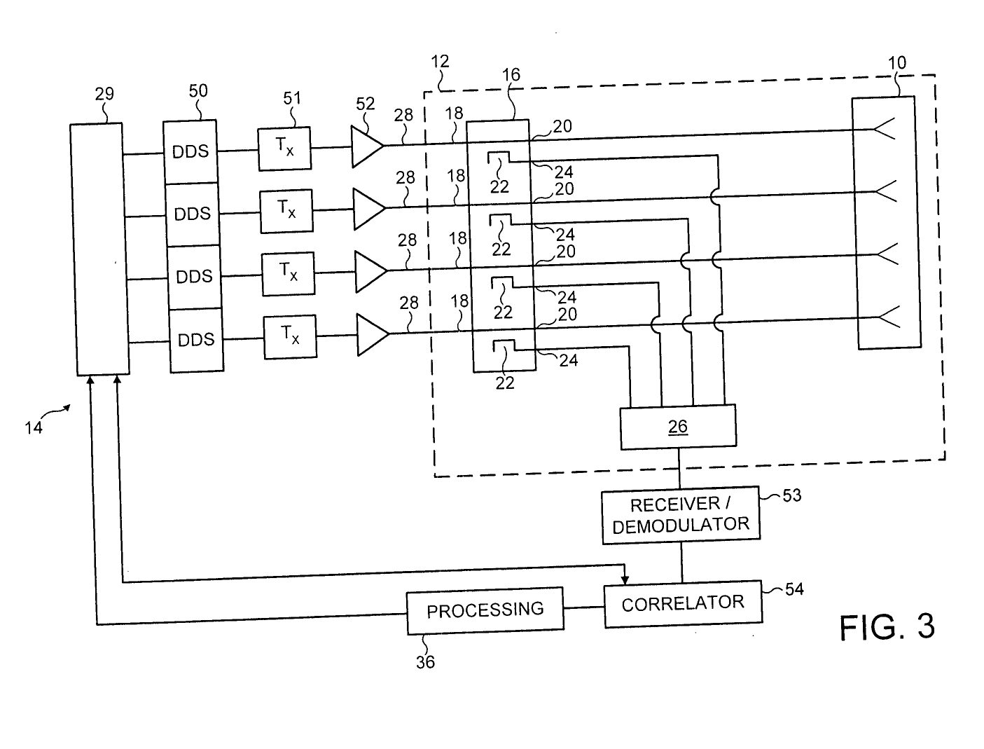

Reference will now be made to FIG. 3 which shows a block diagram of elements of a first base transceiver station embodying the present invention. In order to simplify the description of a preferred embodiment of the present invention, only four antennas 10 are described as being provided. However, as will be appreciated, it is possible that more than four antennas 10, for example eight antennas 10 may be provided. Each antenna 10 is spaced from the adjacent antenna 10 by a distance of approximately one half wave length or less.

The base transceiver station can be considered in two parts. The first part 12 consists of those elements which are arranged at the mast head. The remaining elements 14 define the second part of the base transceiver station and will be provided at the foot of the mast head or a similar suitable location. The first part 12 is thus arranged at a location remote from the second part 14. The first part 12 of the base transceiver station arranged at the mast head comprises only passive components. In other words, none of these components at the top of the mast head require a power source. This is advantageous.

In addition to the four antennas 10, the first part 16 comprises a coupler arrangement 16. The coupler arrangement 16 has four inputs 18, each of which is arranged to receive a respective signal for one of the antennas 10. The coupler 16 has corresponding outputs 20 which output the respective signal received on the corresponding input to the respective antenna 10. Finally, the coupler 16 includes a coupler 22 for each of the signals intended for the antennas 10. Accordingly, a first coupler 22 is provided to sample the signal intended for the first antenna 10, with second to fourth couplers being provided for the second to fourth antennas 10 respectively. The coupler 16 has four first outputs 24 which output the signal from the coupler elements 22 to a summer 26. The summer 26 sums the outputs from each of the couplers 22. The summed signal is output by the summer 26 to the second part 14 of the base transceiver station.

The second part 14 of the base transceiver station is connected to the first part 12 by cables 28. One cable is provided for each antenna. Accordingly, in the illustrated embodiment of FIG. 3 with four antennas 10, four cables 28 are provided.

The second part 14 of the base transceiver station comprises the usual base transceiver station elements including signal processing unit 29 for generating the signals which are to be transmitted by the antennas and additionally generates the calibration signals. The generation of the calibration signals will be described in more detail hereinafter. The signals generated by the processing unit 29, which may be a digital signal processor are forwarded to respective direct digital synthesisers 50. A direct digital synthesiser 50 is provided for each of the antennas and converts the signals from the baseband to the radio frequency. The base station also comprises conventional transmit elements 51 for each antenna. These elements 51 are entirely conventional and will not be described in any further detail. In series with each of the transmit elements 51 are respective amplifiers 52 which control the gain of the signal. In this embodiment of the present invention the phase of the respective signals applied to the antennas are controlled at the baseband frequency. In some embodiments of the present invention, the gain may also be controlled at the baseband.

The second part 14 of the base transceiver station also receives the summed signal from the summer 26 in a receiver and demodulator 53 which is arranged to receive and demodulate the summed signal. The output of the receiver and demodulator 53 is connected to the input of a correlator 54 which correlates the output of the receiver and demodulator 53 with a signal which represents a summed version of the signals output by the signal processing means 29. The correlator 54 thus also has an input from the signal processing means 29.

The output of the correlator 54 is input to a processing unit 36 which calculates from the outputs of the correlator 54 the correction or calibration values which need to be applied by the signal processing means 29 to the signals to be transmitted by the respective antennas. In this way differences in the cables or other feeders between the first and second parts of the base station can be compensated for.

It should be appreciated that the base transceiver station is also arranged to receive signals. However, this is conventional and will not be described in any further detail hereinafter.

The reference coupler is not necessary where multiple measurement are made in the same slot.

Embodiments of the present invention use a method known as successive phase inversion in order to compensate for the differences in the cables. In particular, successive phase inversion allows the relative phase and amplitude of sets of the signals within each cable to be compensated for during the beam forming. The phase of combinations of the weight generating system are sequentially inverted and the summed antenna performance is measured. As will be discussed later, a choice of a suitable weight inverting matrix allows errors in the feeder cables for each path to be calculated using simple signal processing.

The principle used by embodiments of the invention is that the phase on two antenna paths are adjusted while the other paths are kept unchanged or switched off. An identical signal is fed into paths n and n+1 and one measurement is made with the paths constant and one with the phase adjusted by π/2 in one of the two paths. The difference between the measurements represents the calibration correction for the path where the phase has been altered. In general for an n element antenna system, calibration will take n+1 measurements—an initial measurement with the phase set to be the same for all of the antennas and n subsequent measurements each of which adds π/2 to the phase on one element.

Elements which are not under consideration can be switched off or left constant for each measurement.

The phase inversion can take place at the baseband, intermediate frequency or radio frequency. The first embodiment describes the phase inversion taking place in the baseband. The second embodiment will describe the phase inversion as taking place at the radio frequency.

Correlation using this method requires multiple adjustments of the phase to calibrate a single transceiver at a single frequency. This would require either measurement over multiple bursts or multiple calibration within a single burst. The first embodiment described will use multiple calibration within a single dummy burst with the second embodiment using calibration over multiple bursts.

In one preferred embodiment of the present invention, successive phase inversion is applied at the baseband where phase inversion can be performed on selected paths effectively instantaneously, thus removing the need to reduce transmitter power during the phase rotation to prevent the occurrence of spurious transmissions which might be generated during a phase transition of finite duration. This embodiment of the present invention allows calibration of several antenna elements to take place within a single TDMA time slot.

This same technique can be used with intermediate frequency or radio frequency signals. However in the latter cases, satisfactory results may not generally be obtainable during a single time slot unless the phase transition can be accurately controlled, or the transmitter power can be reduced during the phase transition to prevent spurious transmissions. To avoid these requirements, calibration may be performed over a number of time slots as described in the second embodiment.

In the first embodiment, multiple calibration comparisons take place within a single dummy or idle time slot. This has the effect of minimising the calibration time. This is achieved by inverting the phase of selected ones of the signals transmitted to the antenna elements during the course of the burst. Different phase inversion patterns are applied sequentially during the course of the burst. For example, the phase of the transmitted signals might be sequentially altered 4 or 8 times during the course of a single burst. The resultant signal is sampled at the first part 12 of the base station. For each sequential phase inversion, for example, 10-30 symbols of the dummy burst may be sampled and correlated. The process is repeated throughout the 147 useful symbols.

In the GSM standard, a dummy burst is defined. This dummy burst can be used in the calibration method embodying the present invention. Alternatively, any other suitable burst can be used for the purposes of calibration.

This embodiment can be used where the dummy burst is constructed with good autocorrelation properties so that any part of it can be used for the calibration algorithm and accurate amplitude and phase measurements can be made using a small portion of the burst, for example 10-30 symbols.

In preferred embodiments of the present invention, the dummy burst is provided with good autocorrelation properties by, for example, repeating the GSM training sequence throughout the burst.

The phase adjustment may be carried out within the baseband by inverting the bitstream presented to selected ones of the transmitter paths, or at intermediate frequency or radio frequency provided the phase can be inverted without causing spurious transmissions.

The calibration algorithm does not need to execute during the dummy burst. Storage of the samples for each adjustment cycle is sufficient. The calibration algorithm can be executed in non real time between dummy bursts.

The number of calibration measurements possible within a single burst will depend on the number of symbols required to accurately determine the phase and amplitude, and the time required to invert the phase without causing spurious transmissions. For example, time may be required to ramp the burst power down before phase inversion, or the trajectory of the phase inversion may need to be carefully controlled over a number of transmitted symbols.

Embodiments of the present invention permit a transceiver having eight antenna elements to be calibrated for a single frequency in a dummy burst.

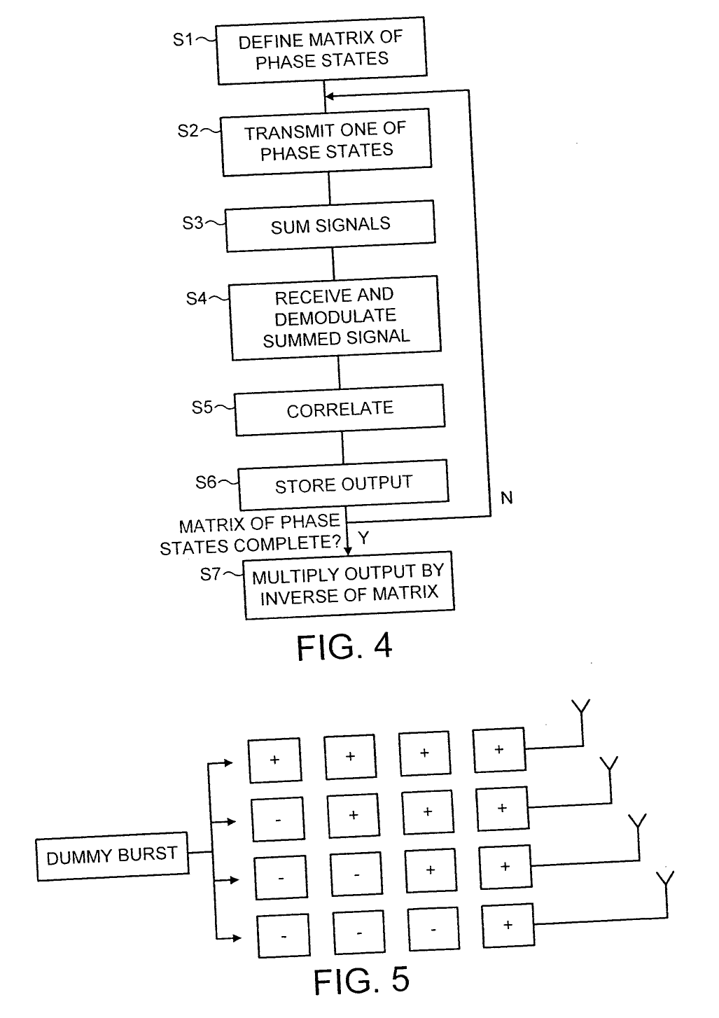

In summary the method comprises the following steps which are shown in FIG. 4. A matrix of phase states is defined in step S1 where columns are antennas 1-n and rows are sequentially transmitted patterns. One of the phase states is transmitted up the n antenna paths in step S2. The radio frequency signals are summed at the top of the mast by summer 26 and then passed down as a single summed radio frequency signal in step S3. The summed signal is received and demodulated by receiver and demodulator 53 in step S4. The received demodulated signal is correlated by correlator 54 with the summed version of the signals before they were passed to the mast head via the cables in step S5. This gives a complex number which is the correlation output and which is stored in step S6. This is repeated for the n states required to calibrate the n antennas. In particular, if not all of the phase states of the matrix have been transmitted, then steps S2 to S6 are repeated until all of the phase states have been transmitted. If all of the phase states have been transmitted, then the n stored complex numbers are taken and multiplied by the inverse of the matrix initially defined, in step S7 in the processor 36. This results in n new complex numbers representing the errors on each antenna path. This calibration information is provided to the signal processing means 29 which uses this information to correct for differences in the paths between the bottom of the mast head and the top thereof.

The method described in relation to FIG. 4 will now be described in more detail. The combined signal c output by the summer can be processed back down at the second part of the base transceiver station and can be written as

$$c = {\sum }_{j = 1}^{m} {a}_{j} {s}_{j} \qquad 1$$

Where aⱼ is the phase inversion state applied to transmitter path j, and sⱼ is the signal that is measured by the respective coupler 22 which is connected to antenna j

If m multiple correlations are performed in a single dummy burst with different known values of aᵢ then equation 1 can be rewritten as:

$${c}_{i} = {\sum }_{j = 1}^{m} {a}_{ij} {s}_{j} \qquad 2$$

which describes a set of m simultaneous equations with m unknowns sᵢⱼ. In matrix form, equation 2 can be written as

c=As 3

where c=(c₁ C₂ . . . Cₙ)^{T}

and s=(s₁ s₂ . . . sₙ)^{T}

where T is the matrix transpose operation.

$$T = [ \begin{matrix}{a}_{11} {a}_{12} … {a}_{13 } \\ {a}_{21} {a}_{22} \\ ⋮ \\ {a}_{m1} {a}_{mn}\end{matrix} ]$$

This matrix defines the phase states where the columns are antennas 1-n and the rows are the sequentially transmitted patterns by the respective antennas.

Thus s is given by

s=A⁻¹c

The relative phases of the signals are calculated using

Φᵢⱼ=arg (sᵢsⱼ)

One of the phase states defined by matrix A are transmitted by the respective cables to the respective antennas. The signals transmitted are sampled by the coupler arrangement and are summed by the summer. If all the correlations can be performed in a single burst and signals can be turned on and off at will, then just transmitting one signal at a time is possible. A is the identity matrix and c=s.

The summed signal is received and demodulated. The received and demodulated signal is correlated with the signal which was sent. The correlation output takes the form of a complex number which is stored. The steps are repeated for each set of phase states.

If all the signals are on all the time, then a suitable choice for A is the upper triangulation matrix T as defined below:

T₁=1

$${T}_{n} = [ \begin{matrix} 1 \\ {T}_{n - 1} ⋮ \\ 1 \\ - 1 … - 1 \; 1\end{matrix} ]$$

$$T = [ \begin{matrix}1 & 1 & 1 & 1 \\ - 1 & 1 & 1 & 1 \\ - 1 & - 1 & 1 & 1 \\ - 1 & - 1 & - 1 & 1\end{matrix} ]$$

The upper triangle set has the advantage that all of the terms are 1 or −1 and that it has a simple inverse. For example, the inverse for n=4 is given by

$${T}_{4}^{- 1} = 1 / 2 [ \begin{matrix}1 & - 1 & 0 & 0 \\ 0 & 1 & - 1 & 1 \\ 0 & 0 & 1 & - 1 \\ 1 & 0 & 0 & 1\end{matrix} ]$$

The m correlations performed per burst use m orthogonal values for the gain and phase settings. This means that the m gain phase values are updated at least m−1 times per burst.

As explained previously, the number of calibration measurements possible within a single burst will depend of the number of symbols required to accurately determine the phase and amplitude and the time required to invert the phase without causing spurious transmissions. The following table shows for a single GSM burst how many symbols are available for correlation as a function of the number of antenna elements to be calibrated, and the time required to invert the phase of an antenna path to avoid spurious emissions.

| | Settling | Settling | Settling | Settling | Settling | Settling | Settling | Settling |
|---|---|---|---|---|---|---|---|---|
| Antenna | time | time | time | time | time | time | time | time |
| elements | 1 μs | 2 μs | 4 μs | 8 μs | 20 μs | 30 μs | 40 μs | 50 μs |
| 4 | 34 | 34 | 34 | 33 | 31 | 28 | 27 | 25 |
| 5 | 27 | 27 | 26 | 26 | 23 | 21 | 19 | 17 |
| 6 | 22 | 22 | 22 | 21 | 18 | 16 | 14 | 12 |
| 7 | 19 | 19 | 18 | 17 | 15 | 12 | 10 | 8 |
| 8 | 16 | 16 | 16 | 15 | 12 | 9 | 8 | 5 |

As the settling time and the number of antenna elements increase, the number of bits available for the correlation sections fall, and the signal to noise ratio required for accurate calibration increases.

If the signal to noise ratio at the correlator input is given by

γ=s²/2σₙ²

then the variance on the correlator phase estimate is given by

σ_{θ}²=(1/2nγ) radian²

If a phase standard deviation of 5 degrees is required then a correlation over 16 symbols requires a signal to noise ratio of 6.1 dB. In reality, a higher signal to noise ratio is required to allow error contribution from other sources such as the calibration system itself.

By looking at the GSM modulator combination of a differential decoder followed by the GMSK modulator as a rotation by π/2 followed by a filter, the phase inversions required for the upper triangulation approach can be implemented simply by inverting sections of the dummy burst modulated by each base band transmitter.

The inversion of a section of the burst is simple and the baseband implementation means that the phase transition is effectively instantaneous but that there will be no spurious signals generated.

With reference to FIG. 5, there is illustrated an example in which sections of the dummy burst are inverted. The first dummy burst is applied to the first to fourth antennas with no phase shift. The second dummy burst is applied to the first to third antennas with no phase shift but with a phase shift of π/2 to the fourth antennas. The third dummy burst is applied to the first and second antennas with no phase shift but with a phase shift of π/2 to the third and fourth antennas. The fourth dummy burst is applied to all the first antenna with no phase shift but with a phase shift of π/2 to the second to fourth antennas. It should be appreciated that the first to fourth dummy bursts can be applied to the antennas in any order. However, the processor of the information will need to be provided with the information on relative phase of the dummy burst applied to each antenna.

Multiple correlations per burst are advantageous as they:

1. allow the calibrations to be repeated at a reasonable interval;

2. increase the accuracy with which calibration can be carried out, since the inversion of the bitstream is arbitrarily accurate unlike an inversion carried out using analogue components such as phase shifters; and

3. remove the need for the reference coupler described below.

Where multiple sequential phase inversions per burst are not possible, it is necessary to spread the sequential phase inversions across a number of timeslots. Any proposed solution depends on the design of the base transceiver station and the number of antennas to be calibrated.

In many wireless communications systems, including GSM, frequency hopping is used where successive frames are transmitted at different frequencies. Frequency hopping is achieved by altering the frequency of the synthesiser within the base transceiver station. Changing the frequency of the synthesiser causes an arbitrary phase rotation at all the antenna paths between each hop. If not compensated for, this phase rotation may prevent calibration occurring across multiple frames, since sequential phase inversion requires a constant phase baseline.

However in GSM each full rate traffic channel has an idle slot. As illustrated in FIG. 7, these idle slots 100 are grouped such that odd slots have their idle slots in the same frame and even slots have theirs in the same frame but offset by thirteen frames. Thus every 13 frames a “half idle” frame occurs where either the odd, or the even, slots are available for use by the calibration system.

The synthesiser is therefore phase locked for the four idle slots within the half idle frame but is not phase locked between frames. By changing the phase for each of the four idle slots in a half idle frame, a four path antenna system using the matrix described previously in relation to the first embodiment can be calibrated.

However to calibrate a system with more antennas than there are idle slots within a single frame the arbitrary rotation of phase between hops needs to be measured and removed. Two embodiments are presented herein for achieving this. The first method uses a calibration method which “overlaps” antennas across hops to measure and compensate for the arbitrary phase rotation. The second method uses a reference coupler to measure and compensate for the arbitrary phase rotation,

In those embodiments where the phase reference changes during the calibration the phase reference could be carried across frames by overlapping antenna path calibrations. The table below shows an example of overlapping calibration to address this problem. The calibration of antennas 3 and 4 is carried out twice, once at each of the arbitrary phase offsets of the synthesiser. This repeated calibration allows the arbitrary phase rotation to be measured and removed.

| | | frame | | | | | | | | |
|---|---|---|---|---|---|---|---|---|---|---|
| TRX | Frequency | no | antenna paths calibrated | | | | | | | |
| 0 | 0 | 0 | 1 | 2 | 3 | 4 | | | | |
| 0 | 0 | 13 | | | 3 | 4 | 5 | 6 | | |
| 0 | 0 | 26 | | | | | 5 | 6 | 7 | 8 |
| 1 | 0 | 39 | 1 | 2 | 3 | 4 | | | | |
| 1 | 0 | 52 | | | 3 | 4 | 5 | 6 | | |
| 1 | 0 | 65 | | | | | 5 | 6 | 7 | 8 |

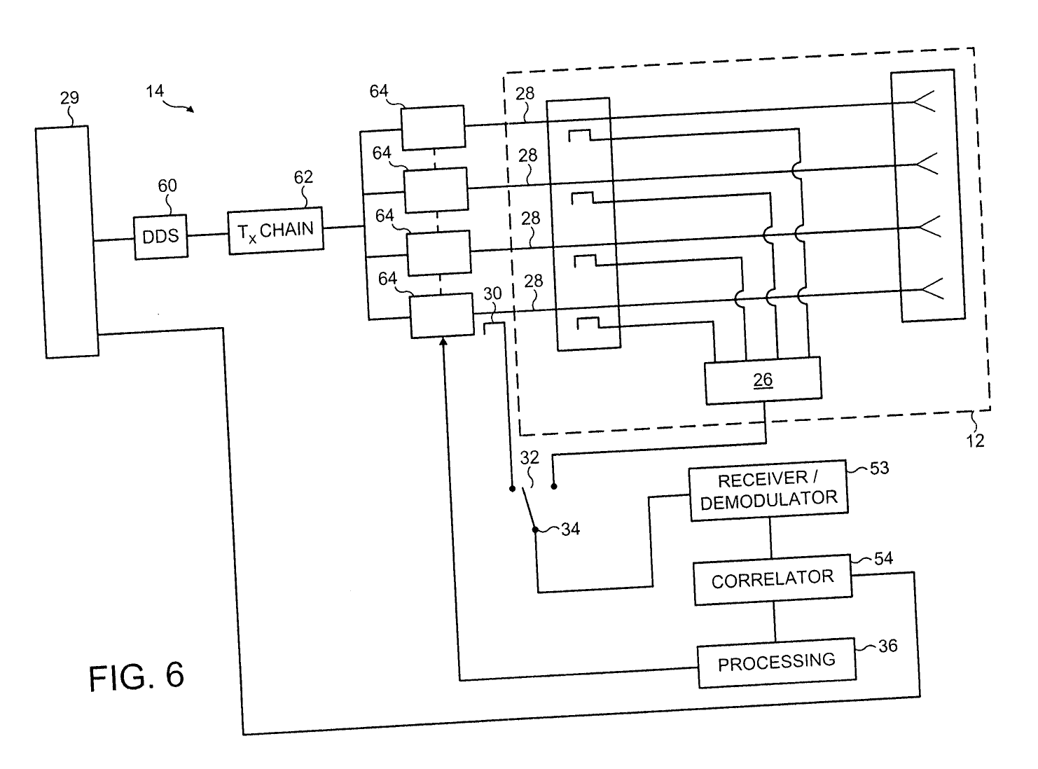

Reference is now made to FIG. 6 which shows the second embodiment of the invention in which the calibration takes place over a number of time slots. The phase of the calibration signals is controlled at the radio frequency level and a reference coupler is used. In particular FIG. 6 shows a base transceiver station which can be used in the second embodiment of the invention. Those elements which are the same as those shown in FIG. 3 are referred to by the same reference numbers and will not be described in any further detail. The first part 12 of the base station is the same as shown in FIG. 3.

The second part of the base station comprises a single direct digital synthesiser 60 which is connected to the output of the signal processing 29. The same signal output by the signal processing means is upconverted to a radio frequency signal by the direct digital synthesiser 60 and is then passed through a conventional tranceiver chain 62. The output of the transceiver chain is input to separate phase and amplitude control units 64 which control the phase and amplitude of the respective signals which are applied to the respective cables 28.

A reference coupler 30 is provided in the second part of the base station. The reference coupler 30 is arranged to sample the signal which is to be passed to one of the cables 28. This coupler 30 has its output connected to a first input terminal of switch 32. A second input terminal of the switch 32 is connected to the output of the summer 26. The output terminal of the switch 32 is connected to a calibration receiver and demodulator 53. Thus the calibration receiver and demodulator 53 can sample signals from either the summer or the reference coupler.

For the method embodying the present invention, the arbitrary rotation described hereinabove is removed by comparing the summed signal from the mast head with a reference signal from the reference coupler. A reference signal is only required from one of the paths but in alternative embodiments a reference signal may be taken from more than one of the paths. In alternative embodiments the reference signal can be taken from any one of the radio frequency paths. During a correlation burst, the switch can be moved between monitoring the sum from the summer and the reference from the reference coupler. The switch could be replaced with a second receiver slaved to the same synthesiser in alternative embodiments of the invention. The measurement taken at the reference coupler is used to remove the arbitrary phase rotation which may occur between hops.

The reference coupler 30 provides a phase signal to remove phase ambiguity between calibrations occurring in different time slots. The accuracy of the amplitude of the reference signal is not important. The reference coupler is needed if the oscillator phase in the transmitter is time varying. The signal measured at the reference coupler is subtracted from the correlation result to cancel out the time variation. The reference coupler may be located at any other suitable location where it sees the oscillator phase and may for example be taken from the output of one of the couplers at the top of the mast head. However, to minimise the number of cables from the mast head, it is preferred that the reference signal be obtained from the second part of the base station.

The remainder of FIG. 2 illustrates an example implementation of how the arrangement of FIG. 3 may be further modified in this embodiment. The correlator is arranged to received the signal from the signal processing means 29. The processor 36 is arranged to provide a calibration correction value as described in relation to the first embodiment. The calibration correction value provided by the processor 36 is used to control the phase and amplitude applied by the respective phase and amplitude control units 64. The phase and amplitude control units use this correction value to ensure that the signals which are output onto the cables 28 have the correct respective delays and amplitude in order to provide a beam in a desired direction.

As the calibration signals do not need to be received by any other element in the cell, the power with which the signals are applied may be less than for normal signals. In alternative embodiments of the invention, the calibration signals maybe transmitted with the same power as normal signals.

In preferred embodiments of the present invention, idle slots are used for calibration, However, in alternative embodiments of the present invention any other suitable time slot may be used.

Embodiments of the present invention to be simple, accurate and non invasive. Additionally the need for active components at the mast head is removed. The method of calibrating is simple and does not require complex electronics to be mounted on or near the antenna array at the top of the mast head.

Embodiments of the present invention have used a phase change of 180 degrees as it is easy to implement. However, in alternative embodiments of the present invention, other phase changes can additionally or alternatively be use.

Whilst embodiments of the present invention have been described in the context of a GSM system, embodiments of the present invention can be use in relation to any other suitable wireless communication system such as code division multiple access system or any other system.

1. A base transceiver station comprising a first part and a second part, said first part comprising a plurality of antennas and said second part being arranged to provide signals for transmission by said plurality of antennas, said first and second parts being connected by feeder means, said second part being arranged to provide a plurality of calibration signals to said first part, said first part comprising summing means for summing the calibration signals received at the first part and means for providing the summed calibration signals to said second part, said second part being arranged to process said summed calibration signals to determine correction values for application by said second part to signals for said plurality of antennas.

2. A station as claimed in claim 1, wherein a plurality of sets of calibration signals are provided to said plurality of antennas.

3. A station as claimed in claim 2, wherein the number of sets of calibration signals is equal to the number of antennas.

4. A station as claimed in claim 2 or 3, wherein at least a plurality of said sets of calibration signals are provided in a single time slot.

5. A station as claimed in claim 2 or 3, wherein only one of said sets of calibration signals are provided in a single time slot.

6. A station as claimed in claim 4 or 5, wherein said time slot comprises an idle time slot.

7. A station as claimed in any of claims 2 to 6, wherein said calibration signals in a set comprise the same signal, at least one of said sets having signals with a phase difference between at least two of said signals.

8. A station as claimed in claim 8, wherein said phase difference comprises 180 degrees.

9. A station as claimed in claim 7 or 8, wherein said phase difference between said signals is applied at baseband.

10. A station as claimed in claim 7 or 8, wherein said phase difference between said signals is applied at an intermediate or radio frequency.

11. A station as claimed in any of claims 2 to 10, wherein a matrix is defined which comprises said plurality of sets of calibration signals.

12. A station as claimed in claim 11, wherein said sets of said matrix are provided to the first part of the base station in turn.

13. A station as claimed in any preceding claim, wherein said second part is arranged to correlate the summed calibration signal with a version of the calibration signal provided by the second part.

14. A station as claimed in claim 13 when appended to claim 11 or 12, wherein the results of said correlation are multiplied by the inverse of said matrix.

15. A station as claimed in any preceding claim, wherein said second part is arranged to provide a reference signal for compensating for phase ambiguities between calibrations.

16. A station as claimed in any preceding claim, wherein said plurality of antennas comprise a phased antenna array.

17. A station as claimed in any preceding claim, wherein said feeder means comprises at least one cable.

18. A station as claimed in any preceding claim, wherein separate feeder means are provided for each of said antennas.

19. A station as claimed in any preceding claim, wherein in use the first part is arranged at a mast head and said second part is arranged at the foot of said mast.

20. A method of calibrating a base transceiver station comprising a plurality of antennas, said method comprising the steps of:
providing a plurality of calibration signals to a first part of said base station from a second part of the base station via feeder means;
summing at the first part of the base station the calibration signals received from the second part;
providing the summed calibration signals to the second part of the base station; and processing said summed calibration signals to determine correction values for application by said second part to signals for said plurality of antennas.
